(19) United States
(12) Patent Application Publication
(10) Pub. No.: US 2025/0149621 A1
(43) Pub. Date: May 8, 2025

(54) Electrode Assembly Support Device

(71) Applicant: SK On Co., Ltd., Seoul (KR)

(72) Inventors: Won Sok YOON, Daejeon (KR); Jae Gyu BYUN, Daejeon (KR); Gi Jeong SEO, Daejeon (KR)

(21) Appl. No.: 18/929,824

(22) Filed: Oct. 29, 2024

(30) Foreign Application Priority Data
Nov. 3, 2023 (KR) 10-2023-0150906

(51) Int. Cl. H01M 10/04

(52) U.S. Cl. CPC H01M 10/0468; H01M 10/0486; H01M 10/0413

(57) ABSTRACT

An electrode assembly support device includes a base portion including a mounting portion on which an electrode assembly including an electrode tab protruding from at least on one side is mounted in a first direction, a thickness direction of the electrode assembly, a body portion coupled to one side of the base portion, and a step portion coupled to the body portion and disposed to be perpendicular to the mounting portion to support the electrode tab, wherein at least a portion of the step portion is configured to protrude in the first direction compared to the mounting portion to form a first step.

### CROSS-REFERENCE TO RELATED APPLICATION(S)

This patent document claims the priority and benefits of Korean Patent Application No. 10-2023-0150906 filed on Nov. 3, 2023, the disclosure of which is incorporated herein by reference in its entirety.

### TECHNICAL FIELD

The disclosure and implementations disclosed in this patent document generally relate to an electrode assembly support device.

### BACKGROUND

Unlike primary batteries, secondary batteries may be charged and discharged and thus may be applied to devices within various fields, such as digital cameras, mobile phones, laptops, hybrid vehicles, electric vehicles, and energy storage systems (ESS). Secondary batteries may be lithium-ion batteries, nickel-cadmium batteries, nickel-metal hydride batteries, or nickel-hydrogen batteries. Alternatively, secondary batteries may be all-solid-state batteries using a solid electrolyte instead of a liquid electrolyte.

Secondary batteries are manufactured as flexible pouch-type battery cells or rigid square or cylindrical can-type battery cells.

A cell assembly may be disposed inside a module housing to form a battery module, and a plurality of battery modules may be disposed inside a pack housing to form a battery pack.

In addition, recently, the formation of the battery module may be omitted, and a cell-to-pack (CTP) method may be used by directly integrating battery cells into a battery pack and connecting the battery pack to a main body frame.

In the process of manufacturing a secondary battery, an electrode assembly may be formed by stacking a positive electrode plate, a negative electrode plate, and a separator. Here, an electrode tab may be formed in the electrode assembly, and the electrode tab may sag due to its own weight.

### SUMMARY

According to an aspect of the present disclosure, a sagging phenomenon of an electrode tab may be alleviated.

According to an aspect of the present disclosure, a height of an electrode tab may be adjusted.

An electrode assembly support device of the present disclosure may be widely applied in green technology fields, such as electric vehicles, battery charging stations, and solar power generation and wind power generation using batteries. In addition, the electrode assembly support device of the present disclosure may be used in eco-friendly electric vehicles, hybrid vehicles, etc. to ameliorate the effects of climate change by suppressing air pollution and greenhouse gas emissions.

In some embodiments of the present disclosure, an electrode assembly support device includes: a base portion including a mounting portion on which an electrode assembly including an electrode tab protruding from at least on one side is mounted in a first direction, a thickness direction of the electrode assembly; a body portion coupled to one side of the base portion; and a step portion coupled to the body portion and disposed to be perpendicular to the mounting portion to support the electrode tab, wherein at least a portion of the step portion is configured to protrude in the first direction compared to the mounting portion to form a first step.

The electrode assembly support device may further include: a fixing pin configured to fix the body portion to the base portion, wherein the body portion and the base portion include a pinhole configured to allow the fixing pin to be inserted thereinto.

The step portion may be located in a central region of the body portion to support and contact at least a portion of the electrode tab.

The electrode assembly support device may further include: a foreign matter blocking portion coupled to the body portion, located on both sides of the step portion, and disposed to be perpendicular to the mounting portion.

The foreign matter blocking portion may form a second step with the mounting portion to cover at least a portion of a side surface of the electrode assembly.

The step portion may include a contact surface in contact with the electrode tab, and the contact surface may be formed to be equal to or greater than a width of the electrode tab.

The step portion may include a contact surface in contact with the electrode tab, and the contact surface may be formed in plural to support the electrode tab.

The step portion may include a contact surface in contact with the electrode tab, and the contact surface may be formed to be smaller than a width of the electrode tab.

The step portion may be detachably coupled to the body portion, and the step portion may include a step adjustment portion configured so that a height of the first step is adjusted.

The step adjustment portion may include a plurality of first step adjustment holes arranged in the first direction and include a step adjustment pin inserted into the plurality of first step adjustment holes, and the body portion may include a second step adjustment hole configured to receive the step adjustment pin.

The plurality of first step adjustment holes may respectively be arranged in the first direction and may be spaced apart from each other by a certain interval.

The plurality of first step adjustment holes may be arranged in multiple rows.

The electrode assembly support device may further include: a driving unit configured to move the step portion in the first direction to adjust the first step.

The driving unit may be coupled to one surface of the body portion, the step portion may include a driving surface formed on a surface in contact with the driving unit to adjust the first step, and the driving unit and the driving surface may be configured to adjust the first step while in contact with each other.

The driving surface may be formed as a rack, and the driving unit may include a pinion in contact with the driving surface and include a motor rotating the pinion.

### BRIEF DESCRIPTION OF DRAWINGS

Certain aspects, features, and advantages of the present disclosure are illustrated by the following detailed description with reference to the accompanying drawings.

FIG. 1 is a perspective view illustrating a state in which an electrode assembly is mounted on an electrode assembly support device according to the present disclosure.

FIG. 2 is an exploded perspective view illustrating a joint relationship between a base portion and a body portion of an electrode assembly support device according to the present disclosure.

FIGS. 3A to 3C are cross-sectional views taken along line I-I′ of FIG. 1.

FIGS. 4A to 4C are front views illustrating various types of step portions.

FIG. 5 is an exploded perspective view illustrating a modified example in which a height of a step portion may be adjusted.

FIG. 6 is a front view illustrating a modified example in which a height of a step portion may be adjusted.

FIG. 7 is an exploded perspective view illustrating a modified example in which a height of a step portion may be automatically adjusted.

FIG. 8 is a cross-sectional view illustrating a modified example in which a height of a step portion may be automatically adjusted.

### DETAILED DESCRIPTION

Prior to the description of the present disclosure, terms and words used in the present specification and claims to be described below should not be construed as being limited to ordinary or dictionary terms, and should be construed in accordance with the technical idea of the present disclosure based on the principle that the inventors may properly define their own inventions in terms of terms in order to best explain the invention. Therefore, the embodiments described in the present specification and the configurations illustrated in the drawings are merely the most preferred embodiments of the present disclosure and are not intended to represent all of the technical ideas of the present disclosure, and thus should be understood that various equivalents and modifications may be substituted at the time of the present application.

Hereinafter, preferred embodiments of the present disclosure will be described in detail with reference to the accompanying drawings. In this case, in the drawings, the same components are denoted by the same reference symbols as possible. Further, the detailed description of well-known functions and constructions which may obscure the gist of the present disclosure will be omitted. For the same reason, some of the elements in the accompanying drawings are exaggerated, omitted, or schematically illustrated, and the size of each element does not entirely reflect the actual size. In addition, in the present specification, the expressions, such as an upper side, a lower side, a side face, and the like, are described based on the drawings and may be expressed differently when the direction of the corresponding object is changed.

Hereinafter, an electrode assembly support device according to the present disclosure will be specifically described with reference to the drawings.

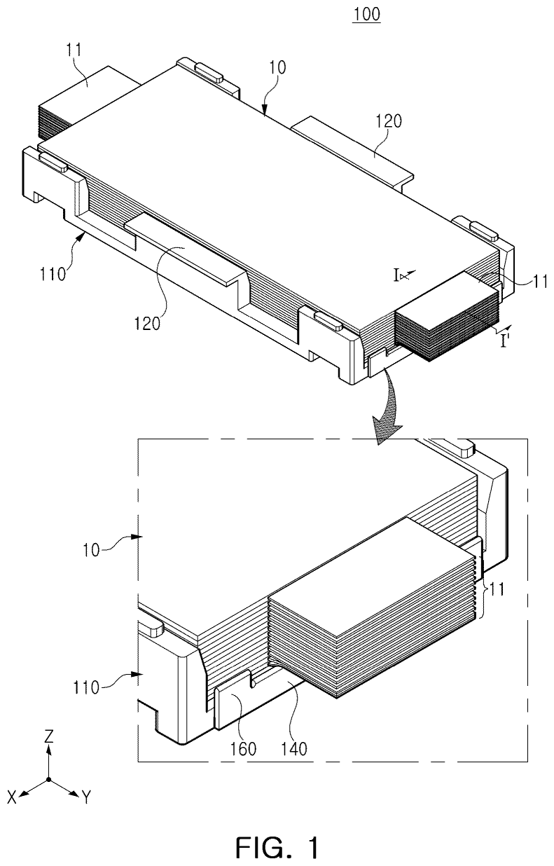

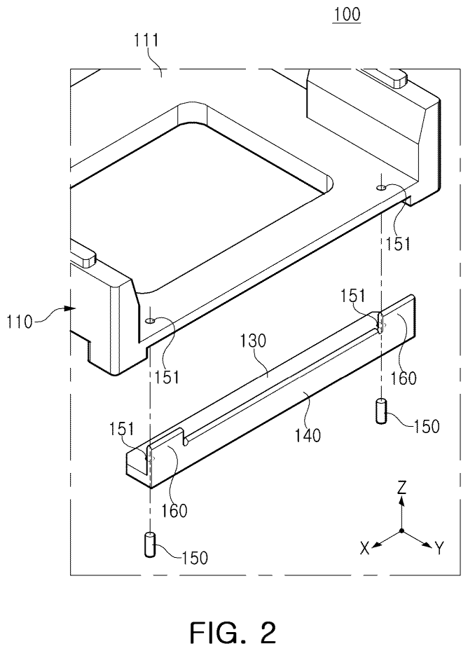

FIG. 1 is a perspective view illustrating a state in which an electrode assembly 10 is mounted on an electrode assembly support device 100 according to the present disclosure, and FIG. 2 is an exploded perspective view illustrating a joint relationship between a base portion 110 and a body portion 130 of the electrode assembly support device 100 according to the present disclosure.

Referring to FIGS. 1 and 2, the state in which the electrode assembly 10 is mounted on the electrode assembly support device 100 and a configuration of the electrode assembly support device 100 may be known.

The electrode assembly 10 may include an electrode plate and a separator. The electrode plate may include a positive electrode plate and a negative electrode plate. The separator may include an insulator interposed between the negative electrode plate and the positive electrode plate. The electrode assembly 10 may be configured as a stack type in which negative electrode plates, positive electrode plates, and separators are alternately stacked, or as a jelly roll type in which stacked negative electrode plates, positive electrode plates, and separators are wound together. The negative electrode plates and positive electrode plates may each have a structure in which a negative electrode active material or a positive electrode active material is coated on foil. For example, the negative electrode plate may be formed by coating graphite or the like on copper or nickel foil, and the positive electrode plate may be formed by coating a transition metal oxide active material on aluminum foil.

The electrode assembly 10 may include an electrode tab 11. The electrode tab 11 may be a portion of the electrode plate protruding from at least one side of the electrode assembly 10. For example, the electrode assembly 10 may have a rectangular shape when viewed from above. In this case, a direction according to a relatively long side may be referred to as a length direction (a Y-axis). The length direction (the Y-axis) may correspond to the Y-axis of the XYZ-axis coordinate system in the drawing. The electrode tab 11 may be located at each end of the electrode assembly 10 in the length direction (the Y-axis). However, without being limited thereto, and the electrode tab 11 may have various shapes, such as two being formed on one side of the electrode assembly 10.

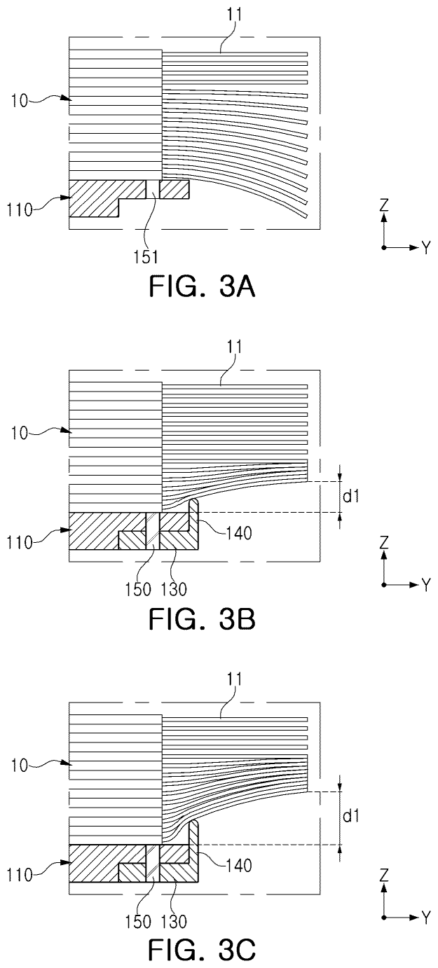

Specifically, the electrode tab 11 may be a portion of an electrode plate formed of a metal material protruding in a square shape. The electrode assembly 10 may be formed by stacking at least one electrode plate. Therefore, referring first to FIG. 3A, the electrode tab 11 of the metal material located at each end may sag due to its own weight. Therefore, the electrode tab 11 may not be fixed to a certain position. Here, the electrode tab 11 may be exposed to the possibility of being damaged by other external factors during a transport process of the electrode assembly 10.

The electrode assembly support device 100 according to the present disclosure may reduce the possibility of the electrode tab 11 being damaged by other external factors by alleviating the sagging phenomenon of the electrode tab 11.

The electrode assembly support device 100 may include the base portion 110, the body portion 130, and a step portion 140.

The base portion 110 may be configured to include a mounting portion 111 on which the electrode assembly 10 is mounted in a first direction (a Z-axis). The first direction (the Z-axis) may be a thickness direction of the electrode assembly 10. The thickness of the electrode assembly 10 increases as more electrode plates are stacked. Therefore, a direction in which the thickness of the electrode assembly 10 increases or decreases may be the thickness direction. Alternatively, the first direction (the Z-axis) may be a direction perpendicular to the ground. Alternatively, the first direction (the Z-axis) may be a direction in which the electrode assembly 10 is moved to be mounted on the mounting portion 111. For example, the electrode assembly 10 may be mounted by moving from the top to the bottom on the mounting portion 111. According to the XYZ-axis coordinate system described in the drawings of this specification, the first direction (the Z-axis) may correspond to the Z-axis. The mounting portion 111 may be configured for the electrode assembly 10 to be mounted and may be a surface of the base portion 110. For example, the base portion 110 may include a flat plate, and a fixing portion 120 may be located on two opposing sides of the four sides of the plate. The mounting portion 111 may correspond to one surface of the plate. The fixing portion 120 may prevent the mounted electrode assembly 10 from being separated from the base portion 110.

The body portion 130 may be a medium for fixing the step portion 140 and a foreign matter blocking portion 160 to be described below. The body portion 130 may be coupled to one side of the base portion 110. The body portion 130 may be coupled to both ends of the base portion 110 in the length direction (the Y-axis).

The electrode assembly support device 100 may additionally include a fixing pin 150 to fix the body portion 130 to the base portion 110, and the body portion and the base portion may include a pin hole 151. For example, the fixing pin 150 may be a pin inserted into the body portion 130 and the base portion 110 to fix the two components in a coupled state. However, this is only an example, and the fixing pin 150 may have various forms, such as screws, rivets, and others. The body portion 130 and the base portion 110 may include a pinhole 151 configured for the fixing pin 150 to be inserted thereinto. The pinhole 151 may be formed to correspond to the length and diameter of the fixing pin 150. The pinhole 151 of the base portion 110 may be formed at both ends of the base portion 110 in the length direction (the Y-axis), and the pinhole 151 of the base portion 110 may be formed in a position corresponding to the pinhole 151 of the base portion 110.

Specifically, the pinhole 151 may be disposed at both ends of the body portion 130 in a second direction (an X-axis). The second direction (the X-axis) may be the width direction of the electrode assembly 10. The width direction of the electrode assembly 10 may be a direction, perpendicular to the length direction (the Y-axis) of the electrode assembly 10 and perpendicular to the thickness direction of the electrode assembly 10. It may correspond to the X-axis in the XYZ-axis coordinate system of the drawing.

The step portion 140 may be configured to support the electrode tab 11 of the electrode assembly 10. The step portion 140 may be coupled to the body portion 130. For example, the step portion 140 may be vertically coupled to one end of the body portion 130. In FIGS. 1 and 2, the step portion 140 is illustrated to be integrally formed with the body portion 130, but without being limited thereto, the step portion 140 may be configured to be separated from the body portion 130. A portion of the electrode tab 11 of the electrode assembly 10 mounted on the mounting portion 111 may protrude outwardly from the base portion 110. The step portion 140 may be located below the electrode tab 11 protruding outwardly from the base portion 110. The step portion 140 may contact the electrode tab 11 at a lower portion of the electrode tab 11 and may support the electrode tab 11. To this end, at least a portion of the step portion 140 may be configured to protrude in the first direction (the Z-axis) compared to the mounting portion 111. Referring first to FIG. 3, the step portion 140 protruding in the first direction (the Z-axis) may form a first step d1 with the mounting portion 111. The degree of supporting the electrode tab 11 may be adjusted by adjusting the height of the first step d1.

FIG. 3 is a cross-sectional view taken along line I-I′ of FIG. 1.

Referring to FIG. 3, a state of the electrode tab 11 may be known according to the height of the first step d1.

The step portion 140 may be coupled to the base portion 110 via the body portion 130, and the height of the first step d1 may vary depending on the size of the step portion 140. For example, the step portion 140 is configured to be perpendicular to the body portion 130, and the height of the step portion 140 may vary. A user of the electrode assembly support device 100 may adjust the height of the first step d1 by selecting the step portion 140 in various sizes.

FIG. 3A is a cross-sectional view illustrating a state in which the step portion 140 is not coupled. The electrode tab 11 to which the step portion 140 is not coupled may experience a sagging phenomenon due to the weight of the electrode tab 11 as shown in the drawing.

FIG. 3B is a cross-sectional view illustrating a case in which the first step d1 is 1 mm. It can be seen that the sagging phenomenon of the lowest electrode tab 11 is alleviated when the first step d1 is 1 mm. The lowest electrode tab 11 may be supported by the step portion 140, and the lowest electrode tab 11 may support the electrode tab 11 located thereabove. Therefore, since each electrode tab 11 is supported by the electrode tab 11 therebelow, the sagging phenomenon of the electrode tabs 11 may be alleviated overall.

FIG. 3C is a cross-sectional view illustrating a case in which the first step d1 is 3 to 5 mm. In this case, the lowest electrode tab 11 is disposed to face upward, and it can be seen that the electrode tabs 11 are generally tilted in a direction in which the highest electrode tab 11 is located.

In the electrode assembly support device 100 according to the present disclosure, the height of the first step d1 may be selected. Therefore, by adjusting the height of the electrode tab 11 during the secondary battery production process, a suitable process environment may be created.

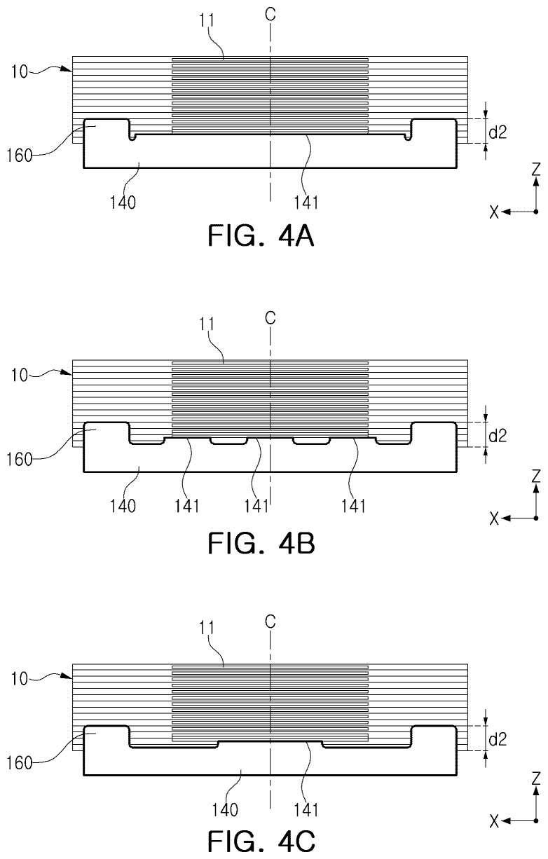

FIG. 4 is a front view illustrating various types of step portions 140.

Referring to FIG. 4, the position of the step portion 140 and modified examples of the step portion 140 may be known.

The step portion 140 may be located in the central region of the body portion 130 to support and contact at least a portion of the electrode tab 11. The body portion 130 may be formed symmetrically with respect to the center C of the electrode assembly 10. Here, the center C of the electrode assembly 10 may coincide with the center C of the electrode tab 11. The step portion 140 may also be formed symmetrically with respect to the center of the body portion 130. The center of the step portion 140 may be in contact with the electrode tab 11.

FIG. 4A illustrates a basic form of the step portion 140. The width of the step portion 140 may be wider than the width of the electrode tab 11. For example, the step portion 140 may include a contact surface 141 in contact with the electrode tab 11. The contact surface 141 may be an uppermost portion of the step portion 140. The contact surface 141 may be formed to be equal to or larger than the width of the electrode tab 11. Therefore, the entire lower region of the electrode tab 11 may be supported by the step portion 140.

FIG. 4B illustrates a modified example of the step portion 140. A plurality of contact surfaces 141 may be formed to support the electrode tab 11. For example, three contact surfaces 141 may be formed. The contact surfaces 141 may be disposed to be spaced apart from each other at a predetermined interval to support the electrode tab 11. Therefore, the weight of the electrode tab 11 may be distributed to each electrode tab 11. However, this is only an example, and the positions and the number of the contact surfaces 141 may be adjusted to vary.

FIG. 4C illustrates another modified example of the step portion 140. The contact surface 141 may be formed to be smaller than the width of the electrode tab 11. However, in this case, the position of the contact surface 141 may be located at the center C of the electrode tab 11. Located at the center C of the electrode tab 11, the electrode tab 11 may be prevented from being tilted in one direction.

The shapes of the step portions 140 illustrated in FIG. 4 are only examples and are not limited thereto and may be formed to vary depending on the size, quantity, and weight of the electrode tab 11.

The electrode assembly support device 100 may further include the foreign matter blocking portion 160. The foreign matter blocking portion 160 may be configured to prevent foreign matter from entering the electrode assembly 10. Referring to FIG. 2 together, the foreign matter blocking portion 160 may be coupled to the body portion 130 and located on both sides of the step portion 140. In addition, the foreign matter blocking portion 160 may be disposed to be perpendicular to the mounting portion 111. For example, the foreign matter blocking portion 160 may be formed of a plate and may be located on both sides of the step portion 140. When viewed based on the body portion 130, the foreign matter blocking portion 160 may be located at both ends of the body portion 130 in the second direction (the X-axis). The foreign matter blocking portion 160 may be disposed to be perpendicular to the mounting portion 111 like the step portion 140. Here, a step formed by the foreign matter blocking portion 160 and the mounting portion 111 may be referred to as a second step d2.

The foreign matter blocking portion 160 may cover at least a portion of a side surface of the electrode assembly 10. For example, among the side surfaces of the electrode assembly 10 mounted on the mounting portion 111, the side surfaces of the electrode assembly 10 located on both sides of the electrode tab 11 may be exposed outwardly. The electrode assembly 10 is a structure in which electrode plates and separators are stacked in layers, and foreign matter entering therebetween may be a factor degrading the performance of the secondary battery. Here, a portion of the foreign matter blocking portion 160 may be disposed to protrude upwardly compared to the mounting portion 111. Therefore, the foreign matter blocking portion 160 may cover at least a portion of the side surface of the electrode assembly 10, thereby preventing foreign matter from being inserted into the side surface of the electrode assembly 10 to some extent.

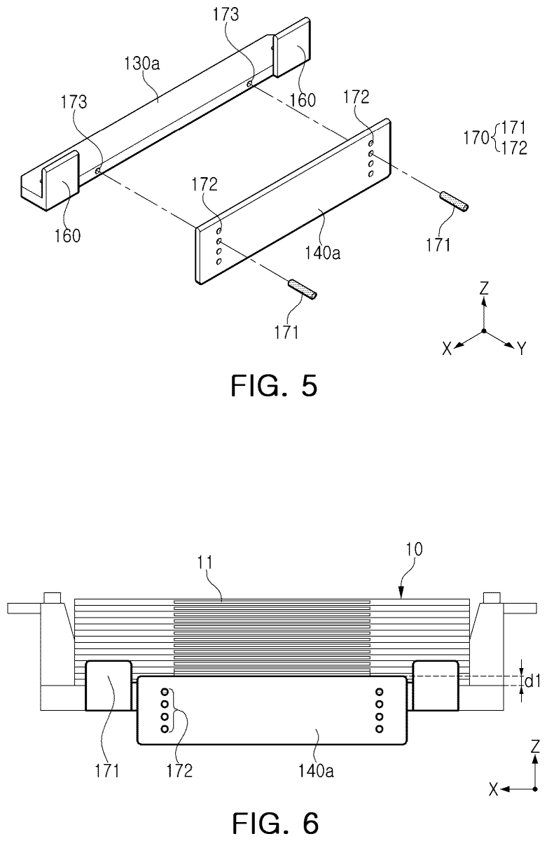

FIG. 5 is an exploded perspective view illustrating a modified example in which a height of a step portion 140a may be adjusted, and FIG. 6 is a front view illustrating a modified example in which the height of the step portion 140a may be adjusted.

Referring to FIGS. 5 and 6, the configuration of the step portion 140a and a body portion 130a in which the height of the first step d1 may be adjusted may be known.

The step portion 140a may be detachably coupled to the body portion 130a and may include a step adjustment portion 170 configured to adjust the height of the first step d1. The user may adjust a coupling position of the step portion 140a and the body portion 130a through the step adjustment portion 170 and adjust the height of the first step d1.

For example, the step adjustment portion 170 may include a plurality of first step adjustment holes 172 disposed in the first direction (the Z-axis) and may include an adjustment pin 171 inserted into the first step adjustment hole 172. Here, the body portion 130a may include a second step adjustment hole 173 configured to receive the adjustment pin 171. The step portion 140a may be configured as a plate separable from the body portion 130a, and the first step adjustment hole 172 and the second step adjustment hole 173 may be located at corresponding positions. Therefore, when the adjustment pin 171 is inserted into the first step adjustment hole 172 and the second step adjustment hole 173, the step portion 140a and the body portion 130a may be fixed.

The plurality of first step adjustment holes 172 may be disposed to be spaced apart from each other by a predetermined interval in the first direction (the Z-axis). Therefore, in order to form a desired height of the first step d1, the second step adjustment hole 173 and the desired first step adjustment hole 172 may be aligned and the adjustment pin 171 may be inserted to adjust the height of the first step d1.

The plurality of first step adjustment holes 172 may be disposed in multiple rows. For example, the plurality of first step adjustment holes 172 may be disposed in two rows in the first direction (the Z-axis) at both ends of the step portion 140 in the second direction (the X-axis). Therefore, the step portion 140 may be stably fixed to the body portion 130.

The electrode tabs 11 of the electrode assembly 10 may be formed in various quantities, shapes, and weights. Accordingly, as seen in FIG. 3, the electrode tabs 11 supported depending on the height of the first step d1 may be disposed in various shapes. The user may select a desired first step d1 through the step adjustment portion 170 of the step portion 140 to obtain a desired arrangement shape of the electrode tabs 11.

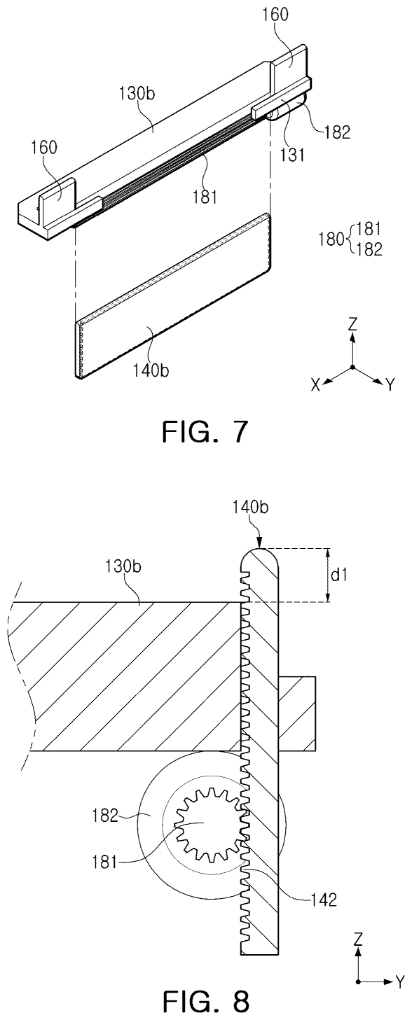

FIG. 7 is an exploded perspective view illustrating a modified example in which a height of a step portion 140b may be automatically adjusted, and FIG. 8 is a cross-sectional view illustrating a modified example in which the height of the step portion 140b may be automatically adjusted.

Referring to FIGS. 7 and 8, the configuration of the step portion 140b and a body portion 130b in which the height of the first step d1 may be automatically adjusted may be known.

The electrode assembly support device 100 of the modified example may further include a driving unit 180. The driving unit 180 may be configured to move the step portion 140b in the first direction (the Z-axis) to adjust the first step d1. For example, the driving unit 180 may be coupled to one surface of the body portion 130b, and the step portion 140b may include a driving surface 142 on a surface in contact with the driving unit 180 to adjust the first step d1. The driving unit 180 and the driving surface 142 may be configured to adjust the first step d1 while in contact with each other.

Specifically, the driving unit 180 may be coupled to a lower portion of the body portion 130b. The driving unit 180 may include a pinion 181 and a motor 182. The motor 182 may rotate the pinion 181 by a rotational method. The pinion 181 may be maintained in a state of being in contact with the driving surface 142. Here, the driving surface 142 may be formed as a rack. Accordingly, the motor 182 may rotate the pinion 181, and the rack may move by the rotation of the pinion 181. Here, the rack may move in the first direction (the Z-axis). In the step portion 140b, slip may not occur in the first direction (the Z-axis) by the pinion 181 and the rack. In order to prevent the step portion 140b from moving out of position in the second direction (the X-axis) or the length direction (the Y-axis), the body portion 130b may include a guide portion 131 configured to surround the step portion 140b. The guide portion 131 may be formed at one end of the body portion 130b and configured so that at least a portion thereof is in contact with the step portion 140b.

According to an aspect of the present disclosure, a sagging phenomenon of the electrode tab may be alleviated.

According to an aspect of the present disclosure, the height of the electrode tab may be adjusted during a secondary battery production process.

Only specific examples of implementations of certain embodiments are described. Variations, improvements and enhancements of the disclosed embodiments and other embodiments may be made based on the disclosure of this patent document.

What is claimed is:

1. An electrode assembly support device comprising:
a base portion including a mounting portion on which an electrode assembly including an electrode tab protruding from at least on one side is mounted in a first direction, a thickness direction of the electrode assembly;
a body portion coupled to one side of the base portion; and
a step portion coupled to the body portion and disposed to be perpendicular to the mounting portion to support the electrode tab,
wherein at least a portion of the step portion is configured to protrude in the first direction compared to the mounting portion to form a first step.

2. The electrode assembly support device of claim 1, further comprising:
a fixing pin configured to fix the body portion to the base portion,
wherein the body portion and the base portion include a pinhole configured to allow the fixing pin to be inserted thereinto.

3. The electrode assembly support device of claim 1, wherein the step portion is located in a central region of the body portion to support and contact at least a portion of the electrode tab.

4. The electrode assembly support device of claim 1, further comprising a foreign matter blocking portion coupled to the body portion, located on both sides of the step portion, and disposed to be perpendicular to the mounting portion.

5. The electrode assembly support device of claim 4, wherein the foreign matter blocking portion forms a second step with the mounting portion to cover at least a portion of a side surface of the electrode assembly.

6. The electrode assembly support device of claim 1, wherein the step portion includes a contact surface in contact with the electrode tab, and the contact surface is formed to be equal to or greater than a width of the electrode tab.

7. The electrode assembly support device of claim 1, wherein the step portion includes a contact surface in contact with the electrode tab, and the contact surface is formed in plural to support the electrode tab.

8. The electrode assembly support device of claim 1, wherein the step portion includes a contact surface in contact with the electrode tab, and the contact surface is formed to be smaller than a width of the electrode tab.

9. The electrode assembly support device of claim 1, wherein the step portion is detachably coupled to the body portion, and the step portion includes a step adjustment portion configured so that a height of the first step is adjusted.

10. The electrode assembly support device of claim 9, wherein the step adjustment portion includes a plurality of first step adjustment holes arranged in the first direction and includes a step adjustment pin inserted into the plurality of first step adjustment holes, and the body portion includes a second step adjustment hole configured to receive the step adjustment pin.

11. The electrode assembly support device of claim 10, wherein the plurality of first step adjustment holes each are arranged in the first direction and are spaced apart from each other by a certain interval.

12. The electrode assembly support device of claim 10, wherein the plurality of first step adjustment holes are arranged in multiple rows.

13. The electrode assembly support device of claim 1, further comprising a driving unit configured to move the step portion in the first direction to adjust the first step.

14. The electrode assembly support device of claim 13, wherein the driving unit is coupled to one surface of the body portion, the step portion includes a driving surface formed on a surface in contact with the driving unit to adjust the first step, and the driving unit and the driving surface are configured to adjust the first step while in contact with each other.

15. The electrode assembly support device of claim 14, wherein the driving surface is formed as a rack, and the driving unit includes a pinion in contact with the driving surface and includes a motor rotating the pinion.
